(19) United States
(12) Patent Application Publication
(10) Pub. No.: US 2015/0262426 A1
(43) Pub. Date: Sep. 17, 2015

(54) Spatial Augmented Reality (SAR) Application Development System

(71) Applicant: University of South Australia, Adelaide (AU)

(72) Inventors: Michael Robert Marner, Adelaide (AU); Markus Matthias Broecker, Adelaide (AU); Benjamin Simon Close, Adelaide (AU); Bruce Hunter Thomas, Adelaide (AU)

(21) Appl. No.: 14/425,156

(22) PCT Filed: Aug. 27, 2013
(86) PCT No.: PCT/AU2013/000952

§ 371 Date: Mar. 2, 2015

(30) Foreign Application Priority Data
Aug. 28, 2012 (AU) 2012903729

(51) Int. Cl. G06T 19/00; G06T 19/20; G06T 15/08; H04N 9/31; G06F 3/01; G06T 15/10

(52) U.S. Cl. CPC G06T 19/006; G06F 3/011; G06T 15/10; G06T 15/08; H04N 9/3147; G06T 19/20; G06T 2219/2008; G06T 2219/012; G06T 2215/16; G06T 2219/2016

(57) ABSTRACT

A Spatial Augmented Reality (SAR) system is described. The SAR system includes a SAR device, such as a computer, and a SAR platform such as a set of projectors and object tracking systems that are used for producing a SAR environment. The SAR device can include a loader for receiving and executing one or more SAR application modules and a SAR engine for receiving the input data and for interfacing between the SAR application modules and the output. The architecture of the SAR engine provides a SAR environment independent interface between the SAR application modules and the projectors and object trackers. The SAR engine is responsible for providing perspectively correct projected images in the SAR environment and performing coordinate transformations, and providing updates to application modules, as well as automating many common tasks.

### TECHNICAL FIELD

The present application relates to spatial augmented reality (SAR) systems. In a particular form the present application relates to systems, modules and environments for developing and implementing SAR applications.

### BACKGROUND

Augmented Reality (AR) is the addition of digital imagery and other information to the real world by a computer system. AR enhances a user's view or perception of the world by adding computer generated information to their view. Spatial Augmented Reality is a branch of AR research that uses projectors to augment physical objects with computer generated information and graphics. Traditionally, projectors have been used to project information onto purpose built projection screens, or walls. SAR on the other hand, locates (or projects) information directly onto objects of interest, including moving objects. SAR systems use sensors to develop a three dimensional (3D) model of the world, and typically include tracking systems that enable them to dynamically track movement of real world objects. Such movements or changes are integrated into the 3D model so that updates can be made to projections as objects are moved around.

SAR systems have considerable flexibility and scalability over other AR systems. Multiple projectors may be used to provide projections onto multiple objects, or multiple surfaces of an object, and the projections may be of varying size (including very large projections). Further high resolution projections can also be provided, either by the use of high resolution projectors, or multiple lower resolution projectors each handling different components of the projection to provide a high resolution output. One advantage of SAR systems is that as the information is projected onto an object (or a surface), the system frees the viewer from having to wear or hold a display device, and the information can be viewed by multiple people at the same time. Users can thus hold physical objects, and make and observe digital changes to the object, and these can be easily communicated to other viewers.

Whilst SAR systems provide flexibility and scalability, they represent a challenging environment to develop applications for, as applications are required to work in a wide variety of viewing environments (platforms), each of which may use a different combination of sensors and projectors. This complexity creates difficulties for developing SAR applications for SAR systems.

### SUMMARY

According to a first aspect, there is provided a spatial augmented reality (SAR) device for use in a SAR environment and for receiving and executing one or more SAR application modules, the SAR device comprising:

at least one processor;

at least one memory;

at least one output for connection to at least one device for human perception;

at least one input for receiving data;

a loader for receiving and executing one or more SAR application modules; and

a SAR engine for receiving the input data and for interfacing between the one or more SAR application modules and the at least one output.

In one form the SAR engine provides a SAR environment independent interface between the one or more SAR application modules and the least one device for human perception.

In one form, the at least one of the devices for human perception comprises a video projector, the input data includes data relating to at least one parameter of at least one surface of at least one object in the SAR environment, and/or data relating to at least one parameter of the video projector.

In one form, the received SAR application modules initiate rendering of one or more images, and the SAR engine interfaces between the one more SAR application modules and the least one output so that the one or more rendered images are perspectively correct when projected on the one or more objects in the SAR environment. Further, for each projector, the SAR engine may configure one or more parameters in the rendering pipeline and performs one or more coordinate transformations to enable perspectively correct projection of the rendered images.

In one form, the SAR engine dynamically loads SAR application modules, and provides inter-module and inter-runtime communication so that the SAR application modules can communicate with each other in a single or multiple SAR instance. The at least one input may also receive information on a change in a state of the one or more objects in the SAR environment and the SAR engine provides messages to the one or more SAR application modules comprising information on the change in the state of the one or more objects.

According to a second aspect, there is provided a spatial augmented reality (SAR) system, the system comprising:

a SAR platform comprising one or more devices for human perception; and

a spatial augmented reality (SAR) device according to the first aspect for use in a SAR environment and for receiving and executing one or more SAR application modules.

In one form the one or more devices for human perception are one or more projectors for projecting one or more images onto one or more objects in a SAR environment, and the SAR platform comprises one or more tracking systems for tracking one or more objects in the SAR environment and/or one or more input devices for receiving input from one or more users.

According to a third aspect, there is provided a computer implemented spatial augmented reality (SAR) engine for use in a SAR system comprising a SAR platform and at least one SAR application module for generating output for use by the SAR platform, the SAR platform comprising one or more devices for human perception, the SAR engine comprising:

a platform interface module for providing a SAR platform independent interface for the at least one application SAR modules, wherein the platform interface module configures the output generation pipeline and transforms output generated by the least one SAR application module generation for use by the SAR platform.

According to a fourth aspect, there is provided a computer implemented spatial augmented reality (SAR) application module for use in a SAR system comprising a SAR engine and a SAR platform, the SAR platform comprising one or more one or devices for human perception, the module comprising:

an initialization module;

an update module for updating the module state; and

an output module for generating output for human perception,

wherein the generated output is SAR platform independent, and the SAR engine provides an interface between the SAR application module and the SAR platform to configure the output for use by the SAR platform.

According to a fifth aspect, there is provided a method of initialising a spatial augmented reality (SAR) device for generating human perceptible displaying information on a surface in a SAR environment, the method comprising:

inputting data relating to the SAR environment into a SAR engine in the SAR device of the first aspect via an input in the SAR device,

wherein the data relating to the SAR environment comprises a list of devices for human perception, and one or more intrinsic parameters and one or more extrinsic parameters for each of the devices for human perception.

In one form, the data is input by reading one or more configuration files, the one or more configuration files comprises:

receiving and processing one or more global configuration options;

receiving a list of resource locations;

receiving and loading a list of SAR application modules; and

receiving a room layout configuration comprising a list of projectors, and one or more intrinsic parameters and one or more extrinsic parameters for each projector.

According to a sixth aspect, there is provided a method for providing spatial augmented reality (SAR) information in a SAR environment, the method comprising:

inputting a SAR application module configured to generate the information into a SAR device of the first aspect initialised according to the method of the fourth aspect; and

executing the SAR application via a SAR engine of the SAR device.

According to a seventh aspect, there is provided a computer implemented plugin module for communicating with a spatial augmented reality (SAR) system from a non SAR system, the SAR system comprising a SAR engine, one or more SAR application modules and a SAR platform, the SAR platform comprising one or devices for human perception, the plugin module comprising:

a message handler module for exchanging messages between a non SAR system and a SAR system, wherein received messages contain information on the state of one or more objects in the SAR system, and transmitted messages contain updates to the state of one or more objects in the SAR system.

### BRIEF DESCRIPTION OF DRAWINGS

Various embodiments will be discussed with reference to the accompanying drawings wherein:

FIG. 1 is a perspective view of a SAR system;

FIG. 2 is a system flowchart of a SAR application;

FIG. 3A is perspective view of a first SAR platform;

FIG. 3B is a perspective view of a second SAR platform;

FIG. 3C illustrates a SAR image formed using multiple projectors;

FIG. 3D illustrates the SAR image formed using a single projector;

FIG. 4 is a system flowchart of a SAR application according to an embodiment;

FIG. 5 is a functional block diagram of a SAR system according to an embodiment;

FIG. 6 illustrates the SAR system in use according to an embodiment;

FIG. 7A is a functional block diagram of a plugin module for exchanging messages between a non-SAR system and a SAR system;

FIG. 7B is a schematic representation of a plugin module for exchanging messages between a non-SAR system and a SAR system;

FIG. 8 illustrates a method of initialising a spatial augmented reality (SAR) device; and

FIG. 9 is a functional block diagram of a computing device.

In the following description, like reference characters designate like or corresponding parts throughout the figures.

### DESCRIPTION OF EMBODIMENTS

Several illustrative embodiments of Spatial Augmented Reality (SAR) systems and components will now be described. The SAR system comprises a SAR device and a SAR platform for producing a SAR environment. The SAR device is a computing device (ie comprising a processor and a memory), with inputs for receiving data and an output for connection to at least one device for human perception (ie the SAR platform). Various embodiments will be described herein. In one embodiment the SAR device comprises a loader for receiving and executing one or more SAR application modules and a SAR engine for receiving the input data and for interfacing between the SAR application modules and the output (ie SAR platform).

In the current specification, the SAR platform is defined as the devices which receive input or generate the SAR output—that is the actual configuration and layout of devices used to generate the SAR environment and to detect changes or inputs. These may be simple devices such as a keyboard, mouse or video projector which can be directly connected to the SAR device, or the input devices may be complex systems such as a tracking system comprising multiple sensors and a separate computing device which processes the sensor input and provides tracking input information to the SAR computing device. The SAR platform may include a tracking system which provides tracking information on tracked objects, or alternatively no tracking system may be provided. In some embodiments some or all objects and surfaces on which information is to be projected or perceived are stationary. The connection of the SAR platform or individual input and output devices of the SAR platform to the SAR device may be via wired or wireless protocols or communications devices or means, including Bluetooth, Wi-Fi, infrared, or other wireless technologies, protocols and means.

In the current specification, the SAR environment is defined to represent the physical environment within which augmented reality outputs generated by the SAR system are output (or may be output). For example if the SAR output was generated by a video projector, then the SAR environment would be defined by the intrinsic and extrinsic parameters of the projector, such as the range within which an image remains visible (eg lamp power), the range at which individual pixels reach a predefined size limit (projection optics), and the position and orientation of the projector which defines the field of view or pointing limits. In some embodiments the SAR environment may be an interior region of space, such as a portion of a room, an entire room, multiple rooms, a region of exterior space (ie outdoor) or some combination. The input devices and output devices may be located within the SAR environment, or they may be located outside of the SAR environment provided they can produce outputs which are perceptible within the SAR environment. That is the SAR platform may be completely outside the SAR environment or partially within the SAR environments. In some circumstances the SAR environment may be taken to include the SAR platform and the physical environment within which SAR outputs are perceptible. Similarly the observers who perceive or sense the outputs, or generate inputs may be located in the SAR environment or they may be located outside of the SAR environment provided they can perceive the SAR outputs.

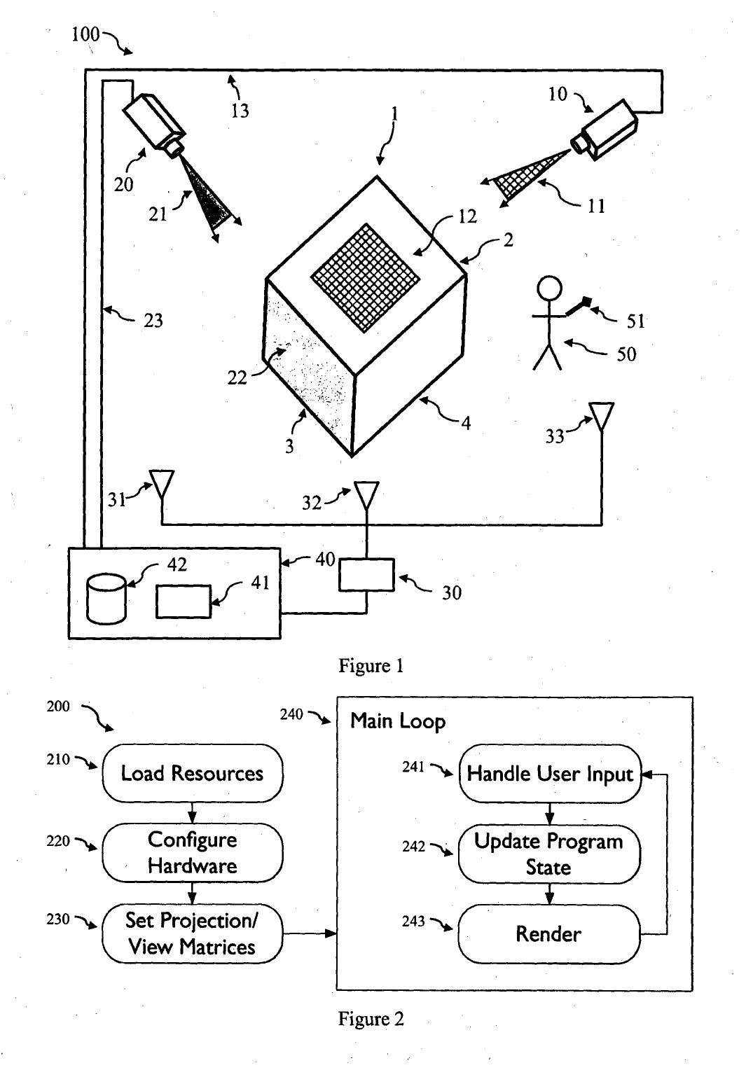

Referring now to FIG. 1, there is shown a perspective view of one embodiment of a Spatial Augmented Reality (SAR) system 100. A physical object 1 located within the SAR environment has a first surface 2, a second surface 3 and a third surface 4. The SAR system 100 comprises a first video projector 10 and a second video projector 20, and a tracking system 30 comprising sensors 31 32 and 33. A computer 40 (the SAR device) comprising a processor 41 and a memory 42 are connected to the tracking system 30 and the first and second projectors via cables 13 and 23 respectively.

The computer executes software code (application code) to implement the SAR system. The application code builds a model of the physical environment in a virtual space and processes received information or data from input devices or systems. The model may include representations of physical objects, as well as virtual objects which can be represented in the physical environment through output devices. The orientation and physical position of objects is maintained using a virtual coordinate space which is a representation of the physical space. The input information may relate to information on changes to the state of objects (e.g. orientation or physical position) or input from input devices such as key presses, mouse click, user gestures etc. The software then produces, generates or renders computer generated graphics or information which is then projected onto one or more objects in the SAR environment.

In this example the first projector 10 projects 11 a first image 12 onto a portion of the first surface 2, and the second projector 20 projects 21 a second image 22 onto the second surface 3. The tracking system 30 can be used to track movements of objects so that the SAR system 100 can update the projected images so that they remain perspectively correct, aligned or otherwise fixed relative to the object as the object moves. Additionally a user 50 may use an input device 51 to provide input to the SAR system. This may be provided directly to the computer using a wired or wireless link, or movements or gestures of the input device may be detected by the tracking system and provided to the computer. The computer thus receives information on changes to the state of one or more objects or other input from users, and this information is processed to generate or render augmented reality images to be projected onto one or more objects by the projectors.

Input data may be received in small amounts or large amounts. For example the input data may relate to one parameter (size, shape, colour, texture, position, orientation etc) of a surface of one object in the SAR environment, or the input data may relate to multiple parameters, multiple surfaces and/or multiple objects. For example the input could indicate a change in the position and orientation of a surface if the object is moved. Input data may relate to objects in the SAR environment, or information relating to an output device, such as a parameter relating to a video projector (eg current position, orientation or pointing angle). In this case the information may be used to enable perspectively correct rendered images on objects in the SAR environment.

The above embodiment uses two video projectors to produce visual output, such as images projected onto surfaces in the SAR environment. In other embodiments, there may be only one projector, or there may be 3 projectors, 4 projectors, 5 projectors, between 5 and 10 projectors, between 10 and 20 projectors, between 20 and 50 projectors, between 50 and 100 projectors or even more than 100 projectors. In other embodiments, the computing device may be connected to other devices which produce information or output for human perception. That is rather than only producing output which is visually perceived, output may also be generated for perception by the senses such as sound, touch or smell. Suitable output devices for human perception include speakers, haptic devices, smoke generators, a heater, air conditioners, humidifiers, fragrance emitter (eg controlled release aerosol container), lasers, holographic generators, etc. Audio output may include sound effects, music, synthesized speech, etc. Such devices can be connected to outputs of the computing device and the SAR application may control generation of outputs. Further outputs from multiple devices may be combined to produce a perceptible output. For example smoke or water vapour may be generated in a portion of the SAR environment, and one or more lasers used to generate a 3D visual representation of an object.

FIG. 2 is a system flowchart 200 of a typical SAR application executing on a SAR device. A SAR system will use a variety of resources and any required resources are first loaded 210. Resources includes textures, 3D geometry, images, videos, graphics shaders, graphics API (e.g. openGL), file loaders, codecs, device drivers etc. The computer then connects to and configures the hardware 220 such as the tracking system (e.g. cameras) and projectors and then sets or loads projector calibration data 230 such as projection/view matrices. Projector calibration is typically performed as an offline process prior to application execution, as calibration is only required if the projector is moved. Projector calibration includes calculating the intrinsic (internal) parameters of the projector, such as the resolution related parameters such as the horizontal and vertical field of view, focal length, number of pixels, etc., as well as extrinsic (external) parameters such as the projector's position and orientation in the environment. This information may be stored in one or more configuration files or in a database. Setting projector calibration data may include loading such configuration data into intrinsic and extrinsic matrices or other data structures. Once any remaining initialisation has been performed, the application enters a main loop 240. The application main loop 240 processes or handles input from the user 241, updates the program/application state 242 based on the user input, tracking systems, etc., and then initiates rendering 243 of graphics for projection by the projector. This loop continues executing until the application is terminated or closed down, at which point any required clean-up is performed (e.g. closing files, freeing resources, etc.).

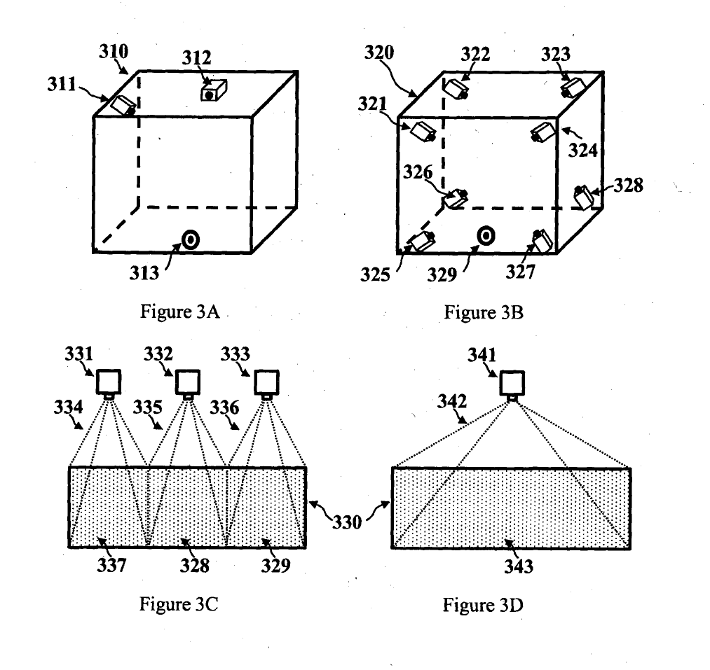

The SAR application is responsible for generating the SAR outputs and responding to input. In prior art systems, the SAR application must typically manage the projectors and tracking systems in use, and respond to any changes or input in real time or near real time. This creates a challenging application development environment as preferably the application should be useable with a range of SAR platforms comprising a range of projection and tracking systems, rather than being specific to a particular site or platform. For example FIGS. 3A and 3B show perspective views 310 320 of a first and second SAR platform respectively. The first SAR platform 310 comprises a first projector 311, a second projector 312 and a sensor (tracking system) 313 for a first environment. The second SAR platform 320 comprises eight projectors 321 to 328 and a sensor (tracking system) 329. If a SAR application is developed for platform 1, then considerable work is required to modify the application to work with the second platform. Similarly resources such as projectors or tracking systems may be upgrade or changed, and such changes need to be supported. For example FIG. 3C illustrates a SAR image 330 formed using three projectors 331 332 333. Each projector projects 334 335 336 respective first second and third portions 337 338 339 of image 330. However the three projectors 331 332 33 may be replaced by a single high resolution projector 341, which can project 342 the entire image 343 onto the required surface. Finally it is desirable to allow different applications to share functionality and allow larger systems to be created.

Thus to address these issues a framework has been developed to facilitate the development of Spatial Augmented Reality (SAR) applications in which an interface is provided for receiving input data and for interfacing between SAR application modules and output devices. This framework will also be referred to as a SAR engine comprising the modules and run time environment that is used to support SAR application modules. The approach taken has been to automate tasks that are common among all SAR applications, to provide a library of functionality for application programmers, and to providing a development methodology or framework that abstracts away the mundane, routine tasks, so that programmers can focus on their application's logic. This functionality may be provided by multiple libraries or computing modules and will be collectively referred to as a SAR engine, or a SAR interface module.

The approach taken is a balance between building applications from scratch each time, and working with a scene graph API such as OpenSceneGraph. Since SAR applications can be put to a wide variety of uses, a flexible SAR engine (or framework or interface) has been developed. The SAR engine provides a SAR environment independent interface which avoids the need to rewrite an application due to a change in the SAR platform, as well as to avoid the need to re-implement aspects that are common to many or all SAR applications. In one embodiment the SAR engine allows application developers to have full access to the underlying system and raw access to the graphics API, with the SAR engine supporting SAR application modules when needed with class abstractions around the raw access.

In particular the SAR engine provides a framework that allows applications to be SAR environment and/or SAR platform independent so that programmers can concentrate on developing applications rather than be bogged down with environment-specific details of the specific physical environment in which their application is to be applied or deployed. That is a specific SAR application module should not be concerned about how many projectors are in use, their resolution, calibration parameters, or how to handle resource changes or substitutions. In one embodiment the SAR engine provides a nm-time environment within a computer for a SAR application module (or modules). The SAR engine provides a platform independent interface between the SAR platform (i.e. projectors and tracking systems) and the SAR application module. The SAR application module can work in a virtual coordinate space and track objects within the space with the SAR engine handling any required projector configuration or transformation. This approach ensures that an image rendered or generated by the SAR application module is aligned with a target object in the physical environment so that a perspectively correct image will be displayed on the target surface. The SAR application module can ignore the physical limitations or specific details of the actual projectors in use, and simply dictate or request where images (or other output) are to be displayed or projected. In effect the developer of the SAR application module can assume enough projectors are available to project any images, and that these projectors have infinite pixel resolution and can be accurately pointed to any location and focussed. Instead the implementation details can be left to the SAR engine to implement with the actual platform in use.

The SAR engine acts as an interface between the SAR platform and the SAR application module, and abstracts input from a user, such as keyboard and mouse input, as well as data from tracking systems (if used). Thus a SAR application module receives information on a change in a state of the one or more objects and then initiates rendering of an image (or images) for the object (or objects) in a virtual or model coordinate space. The SAR engine configures the rendering pipeline such as by configuring one or more parameters of a projector and performing any coordinate transformations to enable perspectively correct projection of the rendered image onto the one or more objects in the physical environment requested by a SAR application module (this will be described in detail below). The SAR engine may also detect and configure the SAR platform and receives and processes tracking information to provide information on a change in a state of the objects to the SAR application module. Other functionality includes managing SAR system resources for rendering images so that a SAR application module does not need to configure the output prior to rendering an image for projection onto an object.

To enable application developers to take advantage of the SAR engine (and associated platform abstraction benefits) a particular programming methodology or interface for SAR application modules may be defined. A SAR application which is packaged into a module (or modules) that implements the interface can be loaded at runtime by the engine (or framework). An embodiment of an interface is presented in Table 1 below:

TABLE 1
class Module
{

public:

Module (const std::string& name, SystemManager& sysMgr);
virtual ^{~}Module( );
virtual void init(const OptionList& options);
virtual void update(unsigned int timestamp);
virtual void draw(const Projector* p);
virtual void handleInput(const SDL_Event& event);
virtual void handleMessage(const Message* msg);

protected:

SystemManager& mSystemManager;

};

The above approach allows application programmers to focus on the logic of the application. Everything else is abstracted away and provided by the SAR engine (framework) and the application can be platform and projector independent (or agnostic). In the above embodiment this is accomplished in the interface by separating the application's logic (the update method) from rendering to the projector (the draw method). In particular update is called once for each pass through the main application loop, and draw is called for each projector within the main application loop. This approach allows a module to assume that when its draw method is called, the projector parameters have been correctly set or configured in the rendering pipeline, such that the (virtual) coordinate space used during the draw method aligns with the coordinate space of the real world. This ensures that anything drawn will align correctly with objects in the real world and will appear perspectively correct, and thus give the correct impression of height, width, depth, relative positions, etc of the projection on the object to an observer. By forcing applications to conform to the above module interface, modules can be dynamically loaded and unloaded at runtime, and multiple modules can be run simultaneously, enabling application developers to build complex applications from smaller building blocks.

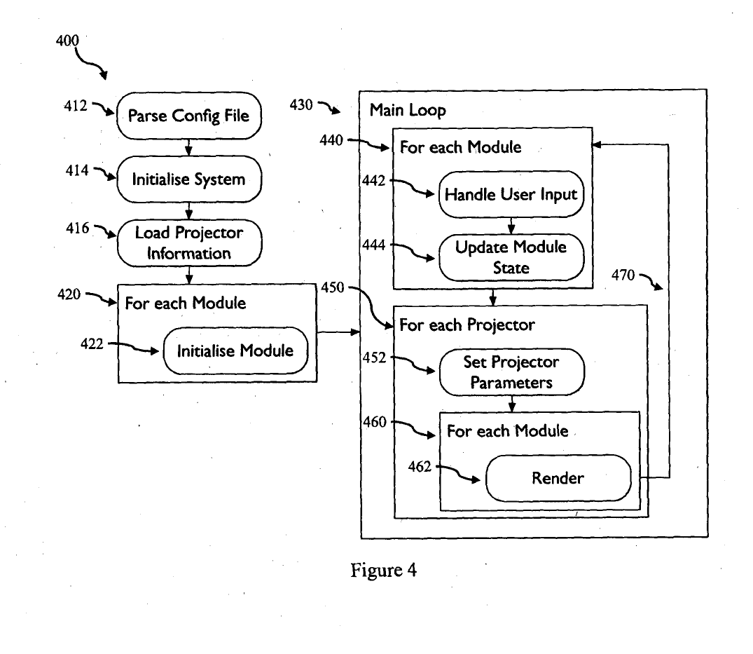

In one embodiment the SAR engine features a modified application flow from that presented in FIG. 2. FIG. 4 is a system flowchart 400 of a SAR application according to an embodiment. The new application flow illustrated in FIG. 4 allows for any number of application modules to run simultaneously with any number of projectors.

Referring to FIG. 4 a series of initialisation or configuration steps are performed prior to execution of the main loop. They comprise parsing one or more configuration files 412, including loading any modules listed in the configuration file(s), initialising systems graphics 414, and loading projection information (e.g. intrinsic and extrinsic parameters) 418. The required information may be provided in an XML configuration file (or several XML configuration files) which includes global configuration options, location (paths) to resources which can be searched by a resource manager, which modules are to be loaded on system start, their system locations (paths) and any initialisation parameters and the room layout including the location and configuration of any projectors. This may include IDs, intrinsic parameters such as projector resolution parameters (e.g. number of pixels and dimensions), extrinsic parameters such as the projectors position and orientation, and the Gamma for the projector. Then at 420 for each module the initialisation module (or routine) 422 is called (m->init( )).

The initialisation (or init) method includes code to initialise graphics and to access the configuration information which has been loaded in steps 412 to 416. However prior to describing this module it is helpful to first describe the default constructor and destructor. As shown in Table 1, modules must have a default constructor that requires no parameters. This is the only constructor that is used by the SAR engine and may include static initialisation. However, as the graphics library/API (e.g. OpenGL) may not have been initialised it is possible to leave any such graphics library/API initialisation (e.g. texture loading, etc.) until the init method is called. The initialisation method is used for all initialisation code other than any static initialisation performed in the constructor. When the init method is executed, the SAR engine guarantees the graphics library (e.g. OpenGL) is ready. Therefore, all graphics related initialisation should be placed inside the init method. In addition, init is the first time a module has access to its configuration options from the configuration file. Additionally the init method has access to a completely set up and ready SystemManager and ResourceManager, providing access to the drawable list, cameras, etc. It is best practice to do only simple static initialisation in the constructor, and save all other initialisation code for the init method.

After configuration and initialisation, the main loop 430 is entered. At step 440, the handle user input method 442 is called for each module. This method handles or processes any input events fired (e.g. keyboard, mouse from SDL) or other input data. The HandleMessage method may also be called to provide a message passing interface for communication between the engine and modules. This allows module-module communication, as well as allowing for messages to arrive from the network.

After processing any input or messages the update module state method 444 is called for each module. The update function is called once each time through the engine's main loop and is used to update the module's state or model of real world. The update module contains the application module's core logic (e.g. what to do in response to change in the state of an object, or in response to received input). In the embodiment shown in Table 1, the timestamp passed in as a parameter is the number of ticks since the system started (if specific update rates are required a time delta can be calculated using the time stamp). If openGL is used, then updating of the OpenGL state should be avoided if the update method is threaded, as openGL is not threadsafe.

Referring back to FIG. 4, at step 450 a loop for each projector is executed which includes setting the projector parameters 452 for example on the graphical processing unit (GPU) as well as performing any required coordinate transformations or other processing to align the physical coordinate space with the virtual coordinate space. Then at step 460 the render method 462 (eg m-draw( )) is called for each module. That is the render/draw method is called once, per projector, each time through the main loop after update is called. The SAR engine guarantees that when the draw method is called, the correct output is selected, and the projector is correctly calibrated. This greatly simplifies module code, as the programmer does not have to configure the output before rendering. Any drawing code is placed in this module. When this method runs, the module has full control over the OpenGL state, and thus the state should be cleaned up at the end of the method. Control is then passed back 470 to the start of the main loop 430 to handle any further user input etc.

The destructor is called when a module is unloaded or the program terminates and should clean up after itself (e.g. close file handles and free other resources). The SAR engine can also support loading and unloading of modules while the system is running. For modules to be unloadable, they should implement an unload method which is called when the module is removed from the system. This method should unload any resources that were created during init, close any file descriptors or network connections, etc.

The flexibility of the module interface is greatly enhanced by providing a mechanism for modules to communicate with each other. In one embodiment the SAR engine implements a Publish/Subscribe message passing system allowing inter-module communication to take place. This enables the modules to provide services to others. For example, modules can be written to interface with different tracking systems. These modules can be swapped out depending on what tracking hardware is available, without having to modify the module that uses the tracking information. Also complex applications can be built from several smaller modules, making software development easier. The SAR engine provides a global message bus. Modules can send messages to the bus at any time, and these messages are published to all modules before the update phase of the main loop.

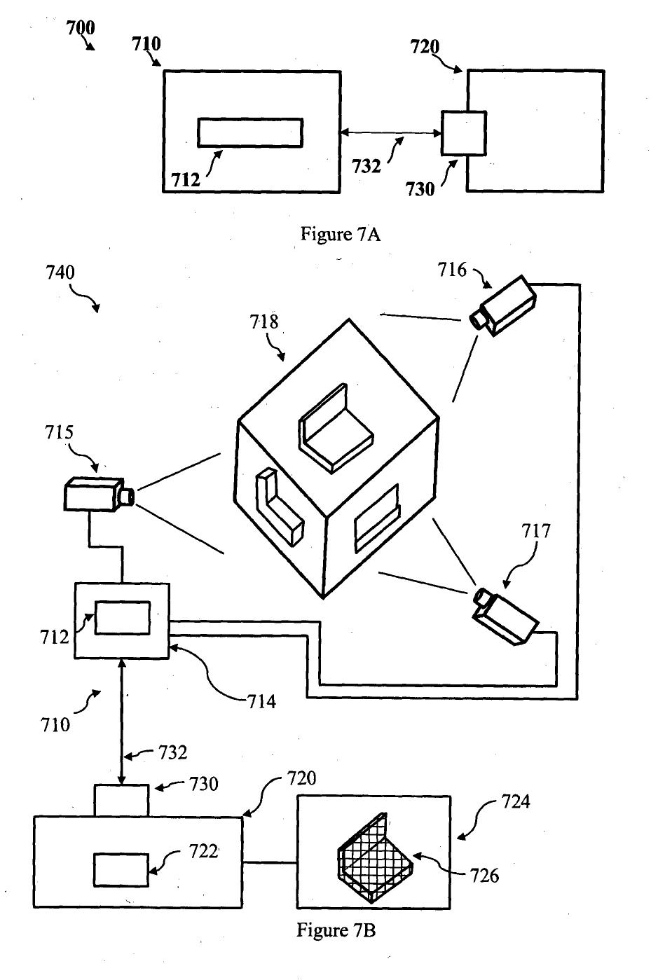

The message handling module or approach may also be extended to provide a plugin module for communicating between a SAR system and a non SAR system. FIG. 7 is a functional block diagram 700 of a plugin module 730 for exchanging messages 732 between a non-SAR system 720 and a SAR system 710 which comprises a message handling module 712. The received messages contain information on the state of one or more objects in the SAR system and the transmitted messages contain updates to the state of one or more objects in the SAR system. The non SAR system may be used to model an object within the SAR system, and the plugin may provide updates on the state of the object to the SAR application modules in the SAR system.

FIG. 7B illustrates a schematic diagram of an embodiment of a plugin module in which the non SAR system 720 is a computing device executing a finite element modelling (FEM) software application 722. A display device 724 displays a wireframe model of an object 726 which is being modelled. A plugin module 730 exchanges messages 732 with a SAR device 714 via the message handling module 712. The SAR platform includes three projectors 715, 716, 717 which projects perspectively correct images of the modelled object 726 onto a box 718. A user could adjust the model of the object, such as by change the length of an edge, and this information could be provided to, or detected by, the plugin module. The plugin module creates a message containing information on the change, and transmits the message to the SAR system 710. A message handler 712 in a SAR application module receives this message, and the application module update the internal model of object 726, and initiates rendering of new images for projection by projectors 715 716 and 717. Similarly an observer could view the images projected on the box, and use hand gestures or other input to alter the model, such as by changing the colour of a surface. This input is provided to the SAR application module, which generates an output message containing information on the change which is sent to, or otherwise made available to, the plugin module 730. The plugin module receives the update message and provides the information to the FEM application which updates the model and the representation on the display device 724.

Providing plugin modules to allow non SAR systems to interact with SAR systems enables a user (or users) to more easily interact with a virtual model of an object. For example a product designer could create a model of a new product in a FEM or similar simulation package such as ANSYS. The model could then be represented in a SAR system, and members of the product development team could view a 3D representation the model and make changes such as to the geometry or materials. These changes can then be provided back to the FEM software which can perform further simulations on the updated model. Whilst a FEM example has been described, the plugin approach could be used with a wide range of non SAR systems and software applications. The implementation could also be performed in a variety of ways. For example the plugin module could be designed to communicate or exchange information directly with a SAR engine, and the SAR engine used to package the information into messages which can be sent or made available to (eg by placing on a message bus or stack) SAR application modules. Also the plugin module may allow one way communication between the SAR system and the non SAR system (ie only to, or only from the SAR system).

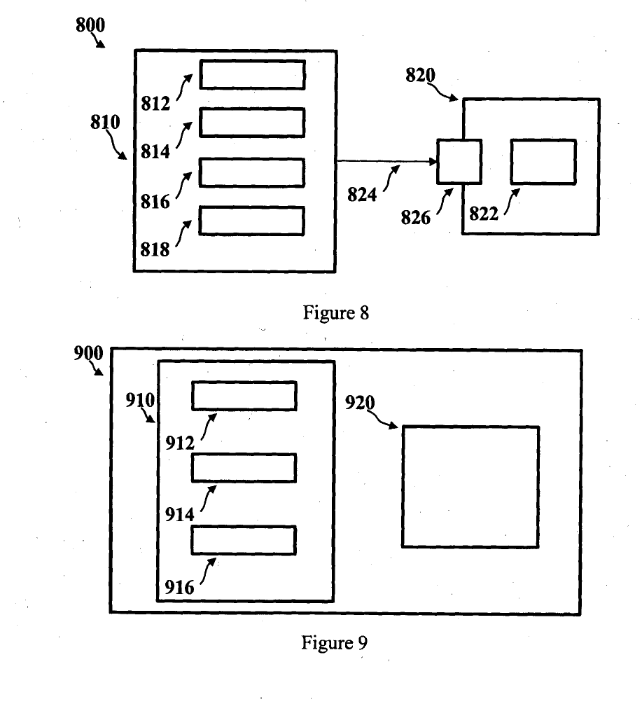

SAR devices will typically require initialisation prior to use in implementing a SAR application, or as part of the overall initialisation of a SAR application. FIG. 8 illustrates a method of initialising a spatial augmented reality (SAR) device 800 comprising the step of inputting data 824 relating to the SAR environment 810 into a SAR interface 822 in a SAR device 820 via an input 826 in the SAR device. The data relating to the SAR environment may comprises a list of devices for human perception, and one or more intrinsic parameters and one or more extrinsic parameters for each of the devices for human perception. The data may be input by reading one or more configuration files as described above. The method may further comprise installing a SAR application module in the SAR device, in which the SAR application module is configured to generate the human perceptible information. The data may be input by reading one or more configuration files as described above and may comprise one or more global configuration options 812, a list of resource locations 814, a list of SAR application modules 816 and a room layout configuration 818. The one or more configuration files may be a single configuration file, several separate configuration files, and/or a hierarchical arrangement in which a master configuration file includes references to further configuration files which are to be read. A further method for providing spatial augmented reality (SAR) information in a SAR environment may be provided comprising inputting a SAR application module configured to generate the information into a SAR device initialised according to the previous method and executing the SAR application via the SAR interface.

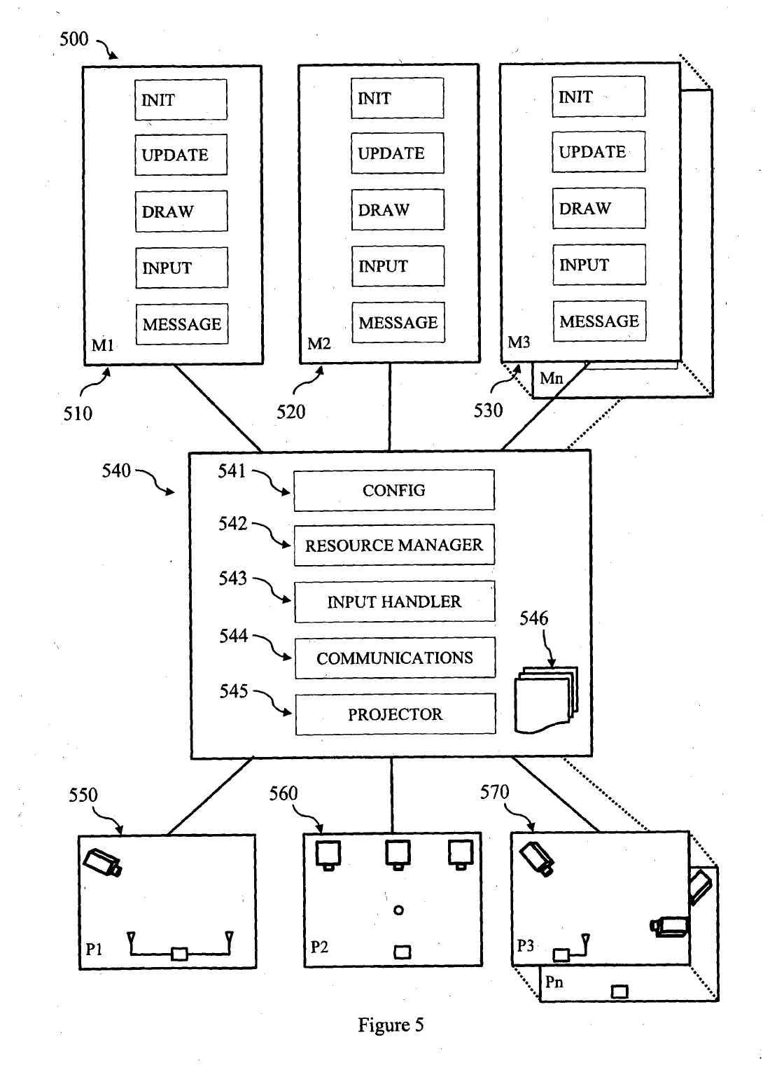

FIG. 5 illustrates a functional block diagram of a SAR system 500 according to an embodiment. The SAR engine 540 provides a run time environment for modules m1 510, m2 520, m3 . . . mₙ 530 which can be used to drive a range of SAR platforms P1 550 P2 560 or P3 . . . Pm 570. The SAR engine 540 supports execution of modules and provides a platform interface module for initializing and setting platform specific parameters, and transforming coordinates in physical space to virtual coordinate space, so as to provide platform independence for the at least one application module. This may be provided in a single module or functionality may be provided in multiple modules. In the embodiment shown in FIG. 5, the SAR engine comprises a configuration module 541 for detecting and configuring the one or more projectors, a resource manager 542 for loading, unloading and managing one or more resources for use by the SAR application modules 510 520 530, an input handler 543 for processing input received from a user and data from the tracking system(s) for use by the SAR application modules a communications module 544 for providing inter-module communication between a plurality of SAR application modules and a projector module 545 or platform interface module for initializing and setting platform specific parameters, and transforming coordinates in a physical space to virtual coordinate space, so as to provide platform independence for the application modules. In addition to the runtime framework for running SAR applications, the SAR engine may also include a range of other modules 546 which can provide a rich API to aid in developing applications. This may include Graphics API Abstraction, Image Loading, Audio a Geometry Loading, and a Coordinate Space Transformer.

Graphics API Abstraction—many SAR applications project information and imagery onto objects in the real world. This necessarily requires interacting with a graphics API. An embodiment of the SAR engine has been implemented using OpenGL, and provides low level abstraction for common constructs in OpenGL. These include GLSL shaders, Frame Buffer Objects, and Textures. These abstractions allow application programmers to use the features without having to deal with the complex setup required by OpenGL.

Image Loading—Many SAR applications will need to load images for projecting onto objects. The SAR engine provides functionality for loading images of any type and providing these to modules as a generic type. This frees the application developer from having to deal with image formats. The SAR engine also provides image sequences, which allow video files to be used in applications.

Audio—While SAR is mostly concerned with visual information, audio playback is also useful to application developers. The SAR engine provides functionality for loading audio files and playing sounds through the computer's sound system.

Geometry Loading—The SAR engine provides a common format for representing and working with 3D geometry in applications. In addition, the SAR engine provides methods for loading different 3D geometry formats from files.

Coordinate Space Transformer—This module can be used to calculate the transformation matrix required to convert between a tracking system's coordinate space and the SAR global coordinate space.

Other functionality can also be provided. For example camera support may be integrated into the SAR engine, rather than in modules. This is because many modules may need to access the same camera, and therefore should receive exactly the same camera image during the update loop. Different modules may need images in different formats. Camera updates can also be threaded so the display loop can run at a speed independent of the frame rate of the cameras.

A tracking system is a hardware/software combination that provides tracking information for one or more objects within the SAR environment. Tracking information can be used for receiving input, or for tracking projection surfaces on objects which move, or can be moved. Suitable tracking systems include the US 1200 optical tracker from Intersense, LED markers for finger tracking, a Wiimote, Polhemus magnetic trackers, OptiTrack, ARToolkitPlus, and Vicon motion capture system.

A tracked object is whatever the tracking system tracks. For the magnetic trackers, the sensor is the tracked object. However, for a system like ARToolkit, the sensor is technically the camera and the object being tracked is a marker. Therefore, these will be referred to collectively as Tracked Objects. Note that the tracked object is not necessarily the object being projected onto. It is specifically whatever the tracking system uses to obtain a position/orientation. Furthermore, different tracking systems have different capabilities. InertiaCubes are only able to give orientation data, whereas ARToolkit is able to give both position and orientation for the same tracked object. Therefore, different types of Tracked Object can provide different information such as just position in the world, just orientation or both position and orientation.

Tracking systems typically define their own coordinate space and local origin which is typically different from the SAR world coordinate space which is typically defined by calibrating the projectors to some known points in the real world. Thus the use of tracking system will typically require a transformation between the two coordinate systems. This may be performed by defining a transformation matrix which transforms locations in the tracking systems into locations in the SAR coordinate space (and vice versa if required). The transformation may be performed by the tracking system, or by the SAR engine.

Another problem arises when projecting onto objects that are tracked. A tracking system will report back a position which can be converted into the SAR coordinate space. However, rotations will be relative to that tracker's local rotation axis. This results in tracking that appears to work as the object is moved, but fails or breaks down when the object is rotated. This may be addressed by transforming a tracker's position and rotation into the object's coordinate system. An offset matrix is calculated to convert the local rotation from the tracker to the object's coordinate system. Table 2 below contains pseudocode for calculating an offset matrix (sMatrix is a square matrix).

The SAR engine may be implemented in C++, Java or other high level computing languages and may be executed by a range of operating systems such as Linux, Windows, etc. Specific modules may be developed for specific tracker systems or projector systems. The SAR engine may be provided as software modules, or computer readable code on computer readable mediums (eg CD, DVD, hard disk, flash disk, etc), or computer readable code which can be downloaded over a communication link and executed locally. The SAR engine may comprise a library of modules (such as those described above), or several libraries, each of which may be linked in when compiling or building a SAR application. In this way functionality may be added to the SAR engine over time, for example as new tracking systems become available, or as other helper modules are developed.

TABLE 2
HEADER FOR EXAMPLE_MODULE

// Assume the object is currently at (0,0,0) and
// rotated to align with the SAR coordinate system
// Matrix a represents object
wcl::SMatrix a(4);
a.storeIdentity( );
// Matrix b represents the current tracking information.
wcl::SMatrix b;
wcl::Vector x(1,0,0,0);
wcl::Vector y(0,1,0,0);
wcl::Vector z(0,0,1,0);
wcl::Vector ax = (a * x).unit( );
wcl::Vector ay = (a * y).unit( );
wcl::Vector az = (a * z).unit( );
wcl::Vector bx = (b * x).unit( );
wcl::Vector by = (b * y).unit( );
wcl::Vector bz = (b * z).unit( );
wcl::SMatrix transform(4);
transform.storeIdentity( );
transform[0][0] = ax.dot(bx);
transform[1][0] = ay.dot(bx);
transform[2][0] = az.dot(bx);
transform[0][1] = ax.dot(by);
transform[1][1] = ay.dot(by);
transform[2][1] = az.dot(by);
transform[0][2] = ax.dot(bz);
transform[1][2] = ay.dot(bz);
transform[2][2] = az.dot(bz);
transform[0][3] = b[0][3];
transform[1][3] = b[1][3];
transform[2][3] = b[2][3];
// Invert the matrix to obtain the correct offset
SMatrix offset = inv(transform);

A range of SAR applications and environments of varying complexity may be developed using the methods and systems described herein. At one end, the SAR module may not require any input or track any objects with the SAR environment. In one embodiment the module could be pre-programmed to perform a series of projections at predefined locations and times. In other variations the predefined locations, predefined times, and/or images to project are included in a configuration file read in at initialisation. In a more complex system, user input to the system could be provided by an input device connected to the system over a wired or wireless connection or link. Suitable input devices include a keyboard, a mouse, a switch, or a hand held device such as a smart phone. These input devices may be used to trigger changes to the projection location, projected image, or projection times. Greater complexity, and typically a more dynamic environment can be provided by including a tracking system.

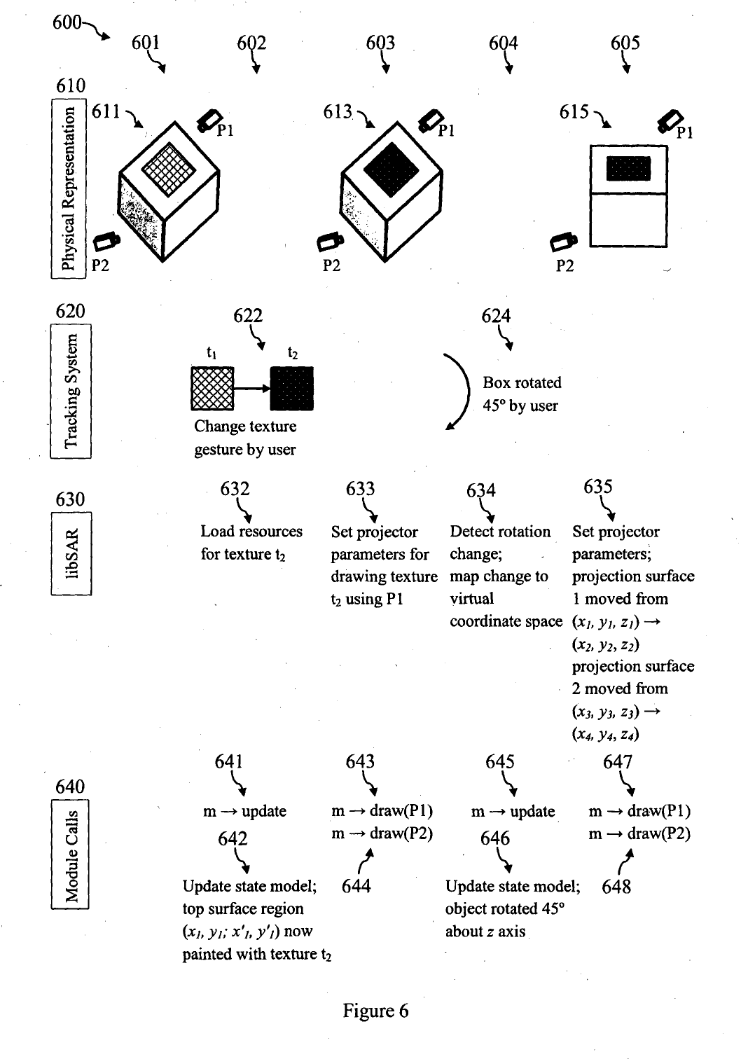

FIG. 6 illustrates the system flow 600 of a virtual painting application implemented using an embodiment of the SAR system described herein and illustrated in FIG. 1. FIG. 6 illustrates the physical representation 610, the tracking System 620 output, the SAR engine (libSAR) processing 630 and the application module calls 640.

At step 601 a cube 611 is shown with a first projector P1 projecting a first image onto a portion of the top surface of the cube, and a second projector P2 projecting a second image onto the left side surface of the cube. At step 602 a user makes an arm gesture which the tracking system 622 recognises as a request for a change in texture of the first image from texture t₁ to new texture t₂. The SAR engine then loads resources for texture t₂ at 632 and the application module calls its update method 641 to update the state model that the top surface region defined by opposite corners (x₁, y₁) and (x′₁, y′₁) is now to be painted with texture t₂. Then at step 603 the SAR engine sets the projector parameters for drawing texture t₂ using projector P1 633. At step 643 and 644 the module draw methods are called for projectors P1 and P2 and the projection on the top of the box 613 is virtually painted with texture t2. At step 604, the user rotates the box by 45° to a new position 615. At step 624 this rotation is detected by the tracking system. At step 634 the SAR engine receives the rotation information from the tracking system and maps the changes in the object coordinates from the physical coordinate system to the virtual coordinate system. At step 645 the modules update method is called to update the state model for the cube to record that it has been rotated by 45° about its z axis. At step 605 the SAR engine sets the projector parameters 635. The first projection surface (top of the cube) has moved from (x₁, z₁) to (x₂, y₂, z₂) 635, and the draw method is then called for the first projector P1 647. At the projector parameters are then set for the second projector. The second projection surface (side of the cube) has moved from (x₃, y₃, z₃) to (x₄, y₄, z₄) and the draw method is then called for the second projector P2 648.

In an alternative embodiment, the arm gesture may be passed to the SAR engine, which may, process and convert this to the request to change texture, and in another alternative embodiment, the tracking system and/or the SAR engine may process the arm gesture to determine the physical coordinates of the arm movement (e.g. from a first location to a second location). The physical coordinates may be transformed to virtual coordinates by the SAR engine.

Pseudocode for a header file and an example module for implementing another embodiment similar to that shown in FIG. 6 is provided in Tables 3 and 4 below. The example code draws an aligned colour square onto the top of a physical box. The default colour of the square is red, and the user may select either red by pressing 1 or green by pressing 2 on an input device such as a keyboard. However if the box is tilted on its side by 45 degrees or more, the square will be painted yellow. To implement this functionality, the ExampleModule class defines private variables squareColor for the colour of the square, and userColor for storing the currently selected user colour. The boxTransform variable stores the orientation of the box, and is set to the identity matrix in the constructor. The init function stores the actual dimensions of the box to be projected onto and registers a tracker. User input is received via the handleInput function and stores the current selection in the userColor variable. The handleMessage function listens for messages from the tracker system, and uses this to update the orientation of the box in the boxTransform variable. The update function detects whether the box is tilted, and if it is tilted the squareColor is set to yellow otherwise the squareColor is set to the userColor value. The draw module handles drawing of the square based upon the position of the box which is determined via the boxTransform variable, and the current value of the squareColor variable. As illustrated in FIG. 4, the draw module is called once for each projector, with the SAR engine handling projector configuration prior to the call to the draw module.

TABLE 3
HEADER FOR EXAMPLE_MODULE

#ifndef EXAMPLE_MODULE_H
#define EXAMPLE_MODULE_H
#include <string>
#include <sar/base/Module.h>
#include <wcl/maths/SMatrix.h>
/**
* A module that projects an aligned coloured square onto
* the top of a physical box.
*/
class ExampleModule : public Module
{

public:

ExampleModule(const std::string&, SystemManager&);
virtual void update(unsigned int timestamp);
virtual void draw(const Projector* p);
virtual void init(const OptionList&);
virtual void handleInput(const SDL_Event& e);
void handleMessage(const Message* m);

private:

// the dimensions of the box
float boxWidth;
float boxDepth;
float boxHeight;
// The tracker that is tracking the box...
std::string trackerName;
// The position and orientation of the box...
wcl::SMatrix boxTransform;
// the colour to draw the square
enum Color {

RED,
GREEN,
YELLOW

};
Color squareColor;
Color userColor;

};
#endif

TABLE 4
EXAMPLE_MODULE

#include <SDL.h>
#include <string.h>
#include <sar/base/OpenGL.h>
#include <wcl/maths/Quaternion.h>
#include “ExampleModule.h”
#define PI 3.14159265
// This call sets up the dynamic loading functionality for the module
MODULE(ExampleModule);
ExampleModule::ExampleModule(const std::string& name,
SystemManager& sysMgr) :

Module(name, sysMgr), boxTransform(4), squareColor(RED)

{

// store the identity matrix for box transform in case we have no
// tracking
boxTransform.storeIdentity( );

}
void ExampleModule::init(const OptionList& options)
{

// Store the dimensons of the box we are projecting onto
boxWidth = atof(options.find(“BoxWidth”)−>second.c_str( ));
boxDepth = atof(options.find(“BoxDepth”)−>second.c_str( ));
boxHeight= atof(options.find(“BoxHeight”)−>second.c_str( ));
trackerName = options.find(“BoxTracker”)−>second;

}
void ExampleModule::update(unsigned int timestamp)
{

// transform a Y vector by the tracking info
wcl::Vector ty = wcl::Vector(0.0, 1.0, 0.0, 0.0) * boxTransform;
// change back to 3 value vectors...
wcl::Vector y1(0.0, 1.0, 0.0);
wcl::Vector y2(ty[0], ty[1], ty[2]);
// Figure out the angle the box is on
double angle = y1.angle(y2);
// once the box is on its side (45 degrees or more),
// change to yellow
if (angle > PI/4 && angle < 7*PI/4)

squareColor = YELLOW;

else

squareColor = userColor;

}
void ExampleModule::draw(const Projector* p)
{

glPushMatrix( );
// transform based on tracking information
glMultMatrixd(boxTransform[0]);
//translate to the top of the box
glTranslatef(0.0f , boxHeight, 0.0f);
// set the color
switch (squareColor)
{

case RED:

glColor3f(1.0f, 0.0f, 0.0f);
break;

case GREEN:

glColor3f(0.0f, 1.0f, 0.0f);
break;

case YELLOW:

glColor3f(1.0f, 1.0f, 0.0f);
break;

}
// draw a square, 50% of the dimensions of the box
glBegin(GL_QUADS);
glVertex3f(−boxWidth/4, 0, −boxDepth/4);
glVertex3f(−boxWidth/4, 0, boxDepth/4);
glVertex3f(boxWidth/4, 0, boxDepth/4);
glVertex3f(boxWidth/4, 0, −boxDepth/4);
glEnd( );
glPopMatrix( );

}
void ExampleModule::handleInput(const SDL_Event& e)
{

// If the user presses 1, set colour to red,
// if they press 2, set the colour to green,
if (e.type == SDL_KEYDOWN)
{

if (e.key.keysym.sym == SDLK_1)

userColor = RED;

else if (e.key.keysym.sym == SDLK_2)

userColor = GREEN;

}

}
/**
* Listens for messages, and if a message contains tracking
* information we are interested in, updates the position
* and orientation of the box.
*/
void ExampleModule::handleMessage(const Message* m)
{

if (m−>type ==
Message::hashType(MESSAGE_TRACKER_UPDATE))
{

TrackerMessage* msg = (TrackerMessage*) m;
if (msg−>id == trackerName)
{

wcl::Quaternion orientation;
orientation.set(msg−>orientation.w,

msg−>orientation.x,
msg−>orientation.y,
msg−>orientation.z);

boxTransform = orientation.getRotation( );
boxTransform[0][3] = msg−>translation.x;
boxTransform[1][3] = msg−>translation.y;
boxTransform[2][3] = msg−>translation.z;

}

}

}

The SAR engine described herein provides an abstraction layer or interface between the SAR application modules and the SAR platforms. The SAR engine allows SAR application modules to be platform independent (or agnostic) and thus provides a flexible and extendable framework for development of SAR systems by handling the interaction with a range of specific SAR platforms and ensuring that images are perspectively correct when projected on the one or more objects in the SAR environment. This significantly simplifies module development and makes it easier to develop Spatial Augmented Reality (SAR) applications and systems. The SAR engine can automate tasks that are common among all SAR applications, provide a library of functionality for application programmers, and provide a development methodology that abstracts away the mundane, routine tasks, so that programmers can focus on their application's logic.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any non-transitory computer or machine readable medium such as a RAM memory, flash memory, ROM memory, EPROM memory, registers, hard disk, a removable disk, a CD-ROM, a DVD-ROM or any other form of computer or machine readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

The SAR device may be a single computing or programmable device, or a distributed device comprising several devices or components operatively connected via wired or wireless connections. The computing device 900 as illustrated in FIG. 9 comprising a central processing unit (CPU) 910, containing an Input/Output Interface 912, an Arithmetic and Logic Unit (ALU) 914 and a Control Unit and Program Counter element 916 which is in communication with input and output devices through the Input/Output Interface, and a memory 920. The Input/Output Interface may comprise a network interface. A graphical processing unit (GPU) may also be included. The computing device may comprise a single CPU (core) or multiple CPU's (multiple core). The computing device may use a parallel processor, a vector processor, or be a distributed device. The memory is operatively coupled to the processor(s) and may comprise RAM and ROM components, and may be provided within or external to the device. The memory may be used to store the operating system and additional software modules that can be loaded and executed by the processor(s). A loader module may be included to load and unload SAR application modules.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers. Where the term device has been used, it is to be understood that the term apparatus may be equivalently used, and the term device is not intended to limit the device or apparatus to a unitary device, but includes a device comprised of functionality related components, which may be physically separate but operatively coupled.

The reference to any-prior art in this specification is not, and should not be taken as, an acknowledgement of any form of suggestion that such prior art forms part of the common general knowledge.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

However the following claims are not intended to limit the scope of what may be claimed in any future patent applications based on the present application. Integers may be added to or omitted from the claims at a later date so as to further define or re-define the invention.

1. A spatial augmented reality (SAR) device for use in a SAR environment and for receiving and executing one or more SAR application modules, the SAR device comprising:
at least one processor;
at least one memory;
at least one output for connection to at least one device for human perception;
at least one input for receiving data;
a loader for receiving and executing one or more SAR application modules; and
a SAR engine for receiving the input data and for interfacing between the one or more SAR application modules and the at least one output.

2. The SAR device as claimed in claim 1, wherein the SAR engine provides a SAR environment independent interface between the one more SAR application modules and the at least one device for human perception.

3. The SAR device as claimed in claim 2, wherein at least one of the at least one device for human perception comprises a video projector.

4. (canceled)

5. (canceled)

6. The SAR device as claimed in claim 3, wherein the received SAR application modules initiate rendering of one or more images, and the SAR engine interfaces between the one more SAR application modules and the least one output so that the one or more rendered images are perspectively correct when projected on the one or more objects in the SAR environment.

7. The SAR device as claimed in claim 6, wherein for each projector, the SAR engine configures one or more parameters for each of the at least one video projector in the rendering pipeline and performs one or more coordinate transformations to enable perspectively correct projection of the one or more rendered images onto the one or more objects in the SAR environment.

8. The SAR device as claimed in claim 1, wherein the SAR engine provides inter-module and inter-runtime communication so that the SAR application modules can communicate with each other in a single or multiple SAR instance.

9. The SAR device as claimed in claim 1, wherein the at least one input receives information on a change in a state of the one or more objects in the SAR environment and the SAR engine provides messages to the one or more SAR application modules comprising information on the change in the state of the one or more objects.

10. The SAR device as claimed in claim 1, wherein the SAR engine comprises a library of application modules.

11. A spatial augmented reality (SAR) system, the system comprising:
a SAR platform comprising one or more devices for human perception; and
a spatial augmented reality (SAR) device for use in a SAR environment and for receiving and executing one or more SAR application modules, the SAR device comprising:
at least one processor;
at least one memory;
at least one output for connection to at least one device for human perception;
at least one input for receiving data;
a loader for receiving and executing one or more SAR application modules; and
a SAR engine for receiving the input data and for interfacing between the one or more SAR application modules and the at least one output.

12. The SAR system as claimed in claim 11, wherein the one or more devices for human perception comprises one or more projectors for projecting one or more images onto one or more objects in the SAR environment.

13. The SAR system as claimed in claim 11, wherein the SAR platform further comprises one or more tracking systems for tracking one or more objects in the SAR environment.

14. The SAR system as claimed in claim 11, wherein the SAR platform further comprises one or more input devices for receiving input from one or more users.

15. A computer implemented spatial augmented reality (SAR) engine embodied in a non-transient computer readable medium comprising instructions for configuring a processor in a SAR system comprising a SAR platform and at least one SAR application module for generating output for use by the SAR platform, the SAR platform comprising one or more devices for human perception, the SAR engine comprising:
a platform interface module configured for providing a SAR platform independent interface for the at least one application SAR modules, wherein the platform interface module configures the output generation pipeline and transforms output generated by the least one SAR application module generation for use by the SAR platform.

16. The computer implemented SAR engine as claimed in claim 15, wherein the platform interface module further comprises:
a communications module configured for providing inter-module communication between a plurality of SAR application modules.

17. The computer implemented SAR engine as claimed in claim 15, wherein the platform interface module further comprises:
a configuration module configured for detecting and configuring the one or more projectors;
a resource manager configured for loading, unloading and managing one or more resources for use by the at least one SAR application module; and
an input handler configured for receiving input, wherein the input comprises user input and information on a change in a state of the one or more objects.

18. The computer implemented SAR engine as claimed in claim 15, wherein the one or devices for human perception further comprises one or more video projectors for projecting one or more images onto one or more objects in a SAR environment, and the platform interface module interfaces between the at least one SAR application module and the least one video projectors so that the one or more rendered images are perspectively correct when projected on the one or more objects in the SAR environment.

19. The computer implemented SAR engine as claimed in claim 18, wherein the platform interface module transforming coordinates between the physical coordinate space of the SAR environment and a virtual coordinate space used by the at least one SAR application module.

20. A computer implemented spatial augmented reality (SAR) application module embodied in a non-transient computer readable medium comprising instructions for configuring a processor in a SAR system comprising a SAR engine and a SAR platform, the SAR platform comprising one or more devices for human perception, the module comprising:
an initialization module;
an update module configured for updating the module state; and
an output module configured for generating output for human perception,
wherein the generated output is SAR platform independent, and the SAR engine provides an interface between the SAR application module and the SAR platform to configure the output for use by the SAR platform.

21. The computer implemented SAR application module as claimed in claim 20, wherein the one or more devices for human perception comprises one or more projectors for projecting one or more images onto one or more objects in a SAR environment and the output module is a drawing module for initiating rendering of an image for projection onto one or more objects in the SAR environment and in use the SAR engine configures the rendering pipeline for each of the one or more video projectors.

22. The computer implemented SAR application module as claimed in claim 20, further comprising an input handler module for receiving user input and information on a change in a state of the one or more objects.

23. The computer implemented SAR application module as claimed in claim 20, further comprising a message handler module for receiving and sending messages to one or more other SAR application modules.

24.-31. (canceled)
